(19) United States
(12) Patent Application Publication
(10) Pub. No.: US 2007/0005701 A1
(43) Pub. Date: Jan. 4, 2007

(54) Synchronizing email content with IM content

(75) Inventors: Eric L. Barsness, Pine Island, MN (US); Gregory C. Place, Rochester, MN (US); John M. Santosuosso, Rochester, MN (US)

Correspondence Address: Biggers & Ohanian, LLP, Suite 970, 504 Lavaca, Austin, TX, 78701-2856, US

(73) Assignee: International Business Machines Corporation, Armonk, NY (US)

(21) Appl. No.: 11/171,784

(22) Filed: Jun. 30, 2005

(51) Int. Cl. G06F 15/16

(52) U.S. Cl. 709/205

(57) ABSTRACT

Methods, systems, and products are disclosed for synchronizing email content with IM content that include identifying email content having at least a threshold correlation with IM content, merging the email content and IM content, and sending the merged email content and IM content to a recipient.

### BACKGROUND OF THE INVENTION

1. Field of the Invention

The field of the invention is data processing, or, more specifically, methods, apparatuses, and products for synchronizing email content with IM content.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Email is a system of world-wide electronic communication in which electronic messages and computer files are exchanged between computers that are connected by a network or networks. Typically, an email client at one computer sends a message to an email server. The message is downloaded from the server by the email client at another computer. Examples of email clients are Microsoft's well-known email applications called Outlook™ and Outlook Express™, and QUALCOMM'S Eudora™. Email has become established as part of the daily business working environment.

Instant messaging (‘IM’) is another type communication application useful in the business environment. Instant messaging is an internet protocol-based application providing for direct communication between users at different devices. An IM client at one computer communicates with an IM server to obtain connection information for an IM client at another computer, and establishes a connection with the other IM client. Examples of IM include Microsoft's Windows Messenger™, AOL's Instant Messenger™, and Mirabilis' ICQ™. Instant messaging (‘IM’) has now become a fully accepted part of the daily business working environment, particularly among high-tech businesses. In fact, the importance of IM to business is recognized by the SEC requirement that brokerage firms save and archive all IM messages for auditing purposes.

Both email and IM are now so pervasive that users now often communicate with each other both by email and IM, switching from one form of communications to the other. Because IM and email are separate applications, however, there is no carry over of information from one application to the other. A conversation among users implemented through intermittent use of both email and IM runs the risk of excluding some users by mistake if those users are accidentally omitted from one or more of the email messages or the IM messages. For example, a group manager may send an email to another group requesting to borrow a server for a weekend. A member of the other group may approve the request by an IM which does not include the other group's manager. While the other group's manager may have received the original request via email, the other group's manager may not be aware of the approval sent via an instant message.

No useful mechanism for combining email content and IM content is currently available. A user can explicitly copy and paste an IM conversation into an email message that is forwarded to all participants of earlier email, but copying and pasting is often cumbersome. There is also no useful mechanism for including email content in IM messages other than also explicitly copying the email content and pasting the content into an IM message.

### SUMMARY OF THE INVENTION

Methods, apparatuses, and products are disclosed for synchronizing email content with IM content that include identifying email content having at least a threshold correlation with IM content, merging the email content and IM content, and sending the merged email content and IM content to a recipient.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for synchronizing email content with IM content according to embodiments of the present invention.

FIG. 2 sets forth a block diagram of automated computing machinery comprising an exemplary computer useful in synchronizing email content with IM content according to embodiments of the present invention.

FIG. 3 sets forth a flow chart illustrating an exemplary method for synchronizing email content with IM content according to embodiments of the present invention.

FIG. 4 sets forth a flow chart illustrating a further exemplary method for synchronizing email content with IM content according to embodiments of the present invention.

FIG. 5 sets forth a flow chart illustrating a further exemplary method for synchronizing email content with IM content according to embodiments of the present invention.

FIG. 6 sets forth a flow chart illustrating a further exemplary method for synchronizing email content with IM content according to embodiments of the present invention.

FIG. 7 sets forth a flow chart illustrating a further exemplary method for synchronizing email content with IM content according to embodiments of the present invention.

FIG. 8A sets forth a line drawing of semantic net of exemplary data representations useful in systems for synchronizing email content with IM content according to embodiments of the present invention.

FIG. 8B sets forth a further line drawing illustrating a semantic net of exemplary data representations useful in systems for synchronizing email content with IM content according to embodiments of the present invention.

FIG. 9 set forth a further line drawing illustrating a semantic net of exemplary data representations useful as another way of identifying keywords in email content conceptually related to other keywords of IM content according to embodiments of the present invention.

### DETAILED DESCRIPTION OF EXEMPLARY EMBODIMENTS

### Detailed Description

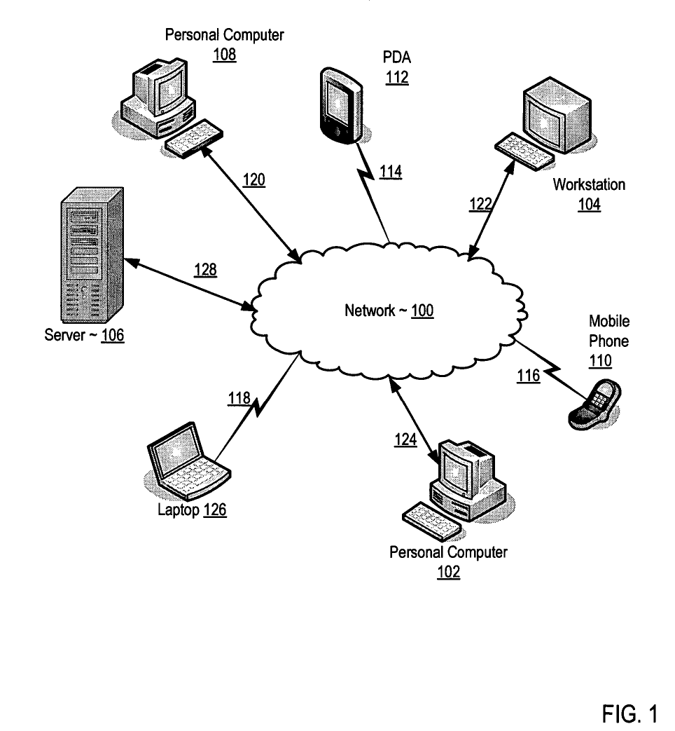

Exemplary methods, apparatuses, and products for synchronizing email content with IM content according to embodiments of the present invention are described with reference to the accompanying drawings, beginning with FIG. 1. FIG. 1 sets forth a network diagram illustrating an exemplary system for synchronizing email content with IM content according to embodiments of the present invention. The term ‘network’ is used in this specification to mean any networked coupling for data communications among two or more computers. Network data communication typically is implemented with specialized computers called routers. Networks typically implement data communications by encapsulating computer data in messages that are then routed from one computer to another. A well known example of a network is an ‘internet,’ an interconnected system of computers that communicate with one another according to the ‘Internet Protocol’ as described in the IETF's RFC 791. Other examples of networks useful with various embodiments of the present invention include intranets, extranets, local area networks (‘LANs’), wide area networks (“WANs”), and other network arrangements as will occur to those of skill in the art.

The system of FIG. 1 includes a data communications network (100). Network (100) provides data communications between devices communicatively coupled to the network (100). Each of the devices (108, 112, 104, 110, 102, 126, and 106) has installed upon it an email module and an IM module and is therefore capable of sending and receiving email and IM.

Devices communicatively coupled to network (100) and capable of sending and receiving email and IM in the system of FIG. 1 include:
workstation (104), a computer coupled to network (100) through wireline connection (122);
personal digital assistant (112), coupled to network (100) through wireless connection (114);
personal computer (108), coupled to network (100) through wireline connection (120);
server (106), coupled to network (100) through wireline connection (128);
laptop computer (126), coupled to network (100) through wireless connection (118);
personal computer (102), coupled to network (100) through wireline connection (124); and
mobile phone (110), coupled to network (100) through wireless connection (116).

The devices (108, 112, 104, 110, 102, 126, and 106) communicatively coupled to network (100) are improved for synchronizing email content with IM content in accordance with embodiments of the present invention. The devices are capable of synchronizing email content with IM content by identifying email content having at least a threshold correlation with IM content, merging the email content and IM content, and sending the merged email content and IM content to a recipient.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

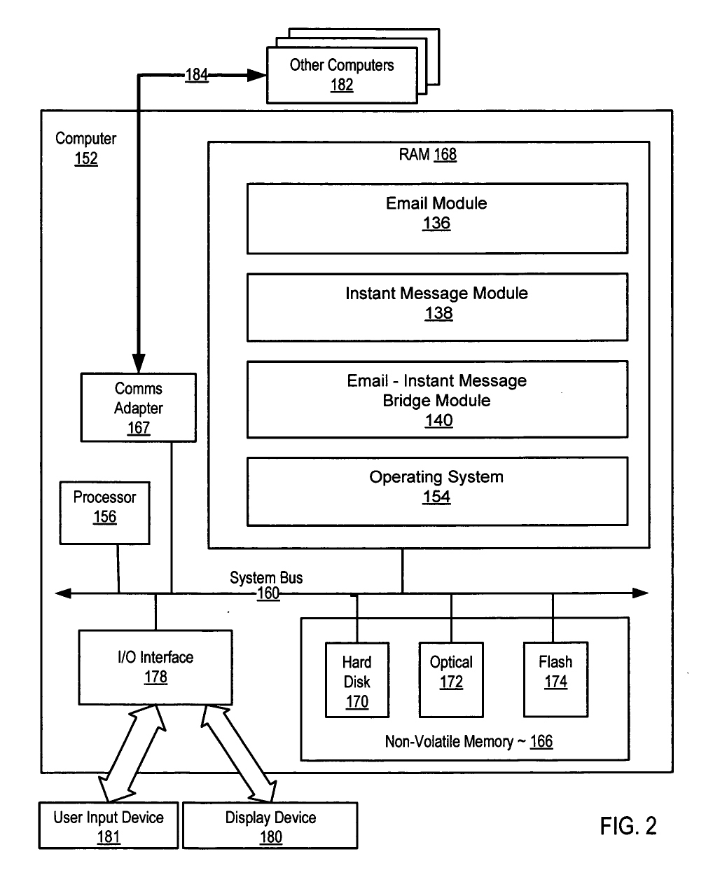

Synchronizing email content with IM content in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in synchronizing email content with IM content according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is an email module (136), computer program instructions for sending, receiving, storing, and retrieving email. Email is a system of world-wide electronic communication in which electronic messages and computer files are exchanged between computers that are connected by a network or networks. Typically, an email client at one computer sends a message to an email server. The message is downloaded from the server by the email client at another computer.

Also stored RAM (168) is an IM module (138), computer program instructions for sending, receiving, storing, and retrieving instant messages. Instant messaging is an internet protocol-based application providing for direct communication between users at different devices. An IM client at one computer communicates with an IM server to obtain connection information for an IM client at another computer and establishes a connection with the other IM client. Having established a connection, the IM clients communicate directly with one another.

Also stored in RAM (168) is an email—instant message bridge module (140). The exemplary email—instant message bridge module (140) comprises a set of computer program instructions improved for synchronizing email content with IM content according to embodiments of the present invention by identifying email content having at least a threshold correlation with IM content, merging the email content and IM content, and sending the merged email content and IM content to a recipient.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), email module (136), IM module (138), and email—instant message bridge module (140) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for synchronizing email content with IM content according to embodiments of the present invention include modems for wired dial-up communications, Ethernet (IEEE 802.3) adapters for wired network communications, and 802.11b adapters for wireless network communications.

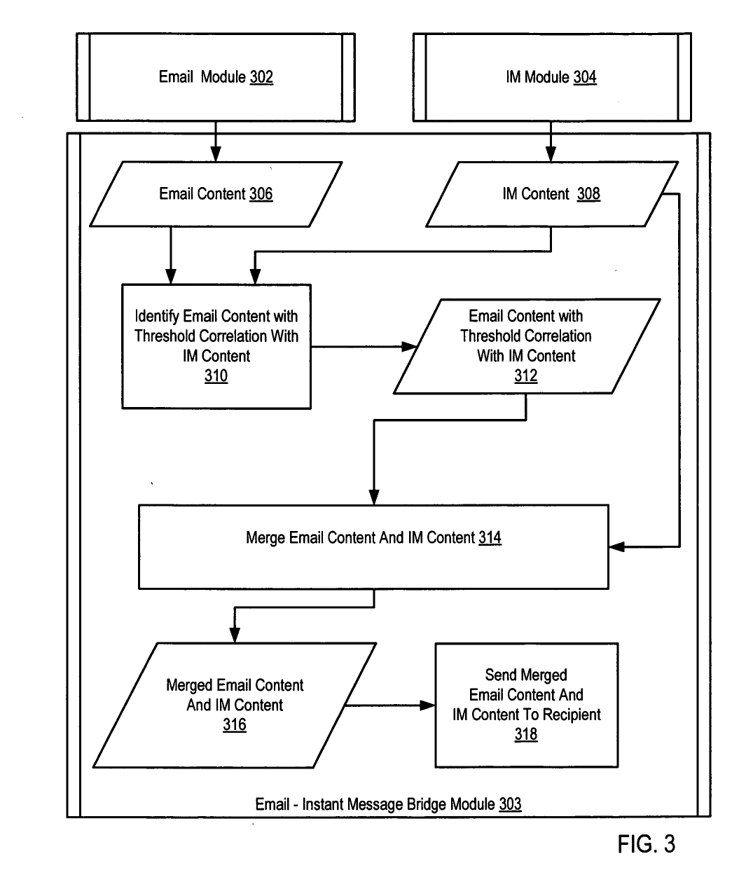

For further explanation, FIG. 3 sets forth a flow chart illustrating an exemplary method for synchronizing email content with IM content according to embodiments of the present invention that includes identifying (310) email content (312) having at least a threshold correlation with IM content (308). Identifying email content having at least a threshold correlation with IM content according to the method of FIG. 3 can be carried out by obtaining email content, obtaining IM content, extracting keywords from the email content, searching for matches between the keywords extracted from the email content and the keywords in the IM content, and rating the correlation between the email content and the IM content in dependence upon the number and type of matches.

Identifying (310) email content (312) having at least a threshold correlation with IM content (308) according to the method of FIG. 3 includes obtaining email content (306) from an email module (302). Obtaining email content may be carried out by issuing commands in the appropriate email application programming interfaces (‘API’) to obtain email content from an email module (302). One exemplary API useful in obtaining email content and compatible with a number of email systems is the Messaging Application Programming Interface (‘MAPI’). MAPI includes a set of application programming interfaces and a dynamic-link library (‘DLL’) component that implements the commands made available through the application programming interfaces. MAPI provides an API for obtaining the content of email messages, creating email messages, and sending email messages.

Identifying (310) email content (312) having at least a threshold correlation with IM content (308) according to the method of FIG. 3 includes obtaining IM content (308) from an IM module (304). Obtaining IM content (308) from an IM module (304) may be carried out by issuing API commands in the particular API used by the particular IM application. In the case of IM, however, unlike email, many different IM modules exist that use different APIs and communicate using different protocols. There is currently no uniform API for different IM modules.

Identifying (310) email content (312) having at least a threshold correlation with IM content (308) according to the method of FIG. 3 includes extracting keywords from the email content (306) and searching for matches between the keywords extracted from the email content and keywords in the IM content. Extracting keywords from the email content (306) may be carried out by extracting all the words from the email content other than common or predefined articles, conjunctions, prepositions, auxiliary verbs, adverbs, and other words or phrases that are predefined not to be keywords. Extracting all the words from the email content other than common or predefined articles, conjunctions, prepositions, auxiliary verbs, adverbs, and other words or phrases that are predefined not to be keywords is presented here for explanation and not for limitation. Extracting keywords may be carried out in a variety of ways as will occur to those of skill in the art, and all such ways are well within the scope of the present invention.

Identifying (310) email content (312) having at least a threshold correlation with IM content (308) according to the method of FIG. 3 also includes rating the correlation between the email content and the IM content. One factor useful in rating the correlation between the email content and the IM content includes the number of matches between the keywords in the email content and the keywords in the IM content. Another factor useful in rating the correlation between the email content and the IM content includes a priority assigned to one or more of the matching keywords. One exemplary factor used in assigning priorities to keywords includes the type of keyword, such for example, as names, email addresses, IM addresses, domain names and so on. Another exemplary factor useful in rating the correlation between the email content and the IM content includes the temporal proximity between one or more email messages containing the email content and one or more IM messages containing the IM content.

Rating the correlation between the email content and the IM content may be carried out by applying in a predetermined formula one or more of the factors described above to obtain a rating value to compare with a predefined correlation threshold. A predetermined formula useful for rating the correlation may be obtained by many useful combinations of the factors described above as well as other factors that will occur to those of skill in the art. One exemplary formula includes simply counting the raw number of matches and dividing the raw number of matches by the number of words in either the email content or IM content. The result of such a formula may then be compared with a threshold value. If the result is greater than the threshold value, then the email content and IM content have a threshold correlation. If the result is less than the threshold value, then the email content and IM content do not have a threshold correlation.

In the example above, the totality of the email content and the totality of the IM content are correlated to determine whether the email content has at least a threshold correlation with IM content. In some cases, however, identifying email content having at least a threshold correlation with IM content may also be carried out by identifying portions or subsets of email content potentially having at a correlation with portions or subsets of IM content and correlating the portions. Identifying email content having at least a threshold correlation with IM content using portions of the email content and IM content may also be carried out by aggregating the correlations of the portions.

The method of FIG. 3 also includes merging (314) the email content (306) and IM content (308). Merging the email content and the IM content may be carried out by creating a new message, such as a new email message, a new IM message, or other message, and inserting all or a portion of the email content and the IM content in the message. Merging (314) the email content (306) and IM content (308) may also include adding an introductory phrase at the beginning of the merged content, such as, for example, “Joe, you may be interested in this IM as related to the following email.”

As discussed above, merging the email content and the IM content may be carried out by creating a new email message containing the IM content and the email content. Merging the email content and the IM content may also be carried out by creating a new IM message containing the merged content. Merging the email content and the IM content may also be carried out by creating a telephone message containing the merged content.

The method of FIG. 3 also includes sending (318) the merged (316) email content and IM content to a recipient. Sending the merged email and IM content to a recipient can be carried out by issuing a MAPI command to send the merged email and IM content as an email message. Similarly, sending the merged email and IM content to a recipient can be carried out by issuing an API command to send an IM message in the API for a particular IM application. In the method of FIG. 3, sending the merged (316) email content and IM content to a recipient may also include sending the recipient an additional message notifying the recipient of the merged content. For example, a recipient who is sent an email message containing the merged content and who does not have an email program open could be sent an instant message notifying the recipient of the email message.

An email-instant message bridge module (303) carrying out the method of FIG. 3 may be implemented as an email application improved according to embodiments of the present invention to obtain IM content from an IM application, an IM application improved according to embodiments of the present invention to obtain email content from an email application, or a separate application which obtains content from both the email application and the IM application and which is programmed to send an email message through the email application and programmed to send an IM message through the IM application.

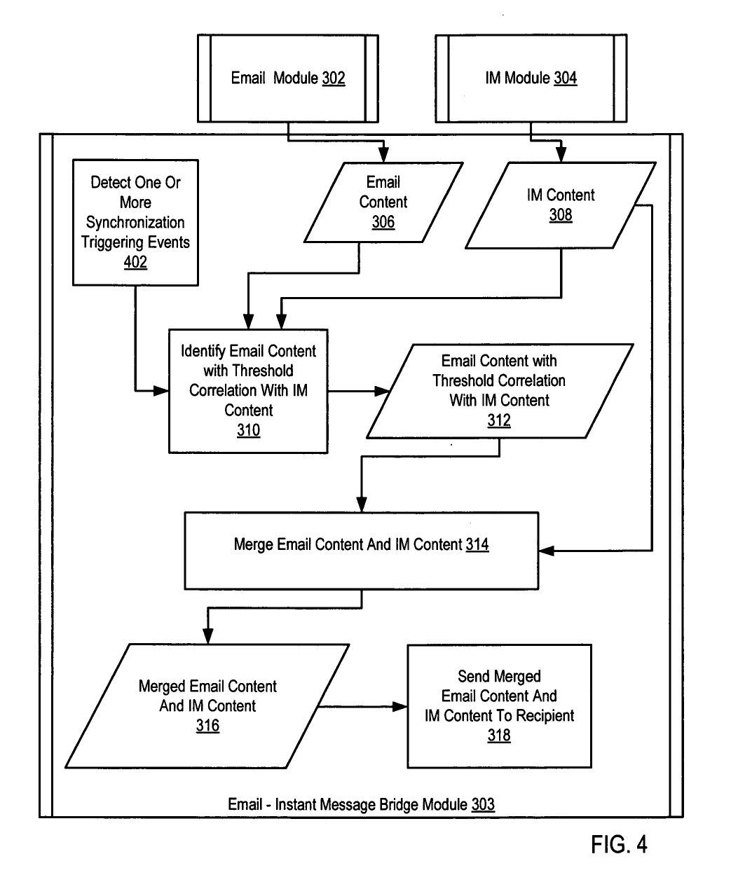

The email-IM bridge module (303) of the present invention may be programmed to operate as a daemon or background process synchronizing email content with IM content according to embodiments of the present invention. The email-IM bridge module (303) of the present invention may also be programmed to begin synchronizing email content with IM content according to embodiments of the present invention upon the detection of one or more synchronization triggering events. For further explanation, FIG. 4 sets forth a flow chart illustrating a further exemplary method for synchronizing email content with IM content according to embodiments of the present invention that includes detecting (402) one or more synchronization triggering events. A synchronization triggering event is an event upon whose detection synchronizing email content with IM content according to embodiments of the present invention is initiated. Synchronization triggering events may include exiting IM, saving an IM message, sending an email, receiving an email, and other events that will occur to those of skill in the art.

Synchronization triggering events may also include user instructions to synchronize email content and IM content. For example, the user's right clicking on the name of an IM contact in the user interface of an email-IM bridge module may present him with a “correlate with email” option. The user's selection of the “correlate with email” option creates a synchronization triggering event initiating the method of FIG. 4. As a further example of an explicit user instruction to synchronize email content and IM content, a user may highlight a word or phrase and then select an option to initiate a search for email content having a threshold correlation with the selected word or phrase. The email-IM bridge module presents to the user a list of email messages whose content has a threshold correlation with the word or phrase.

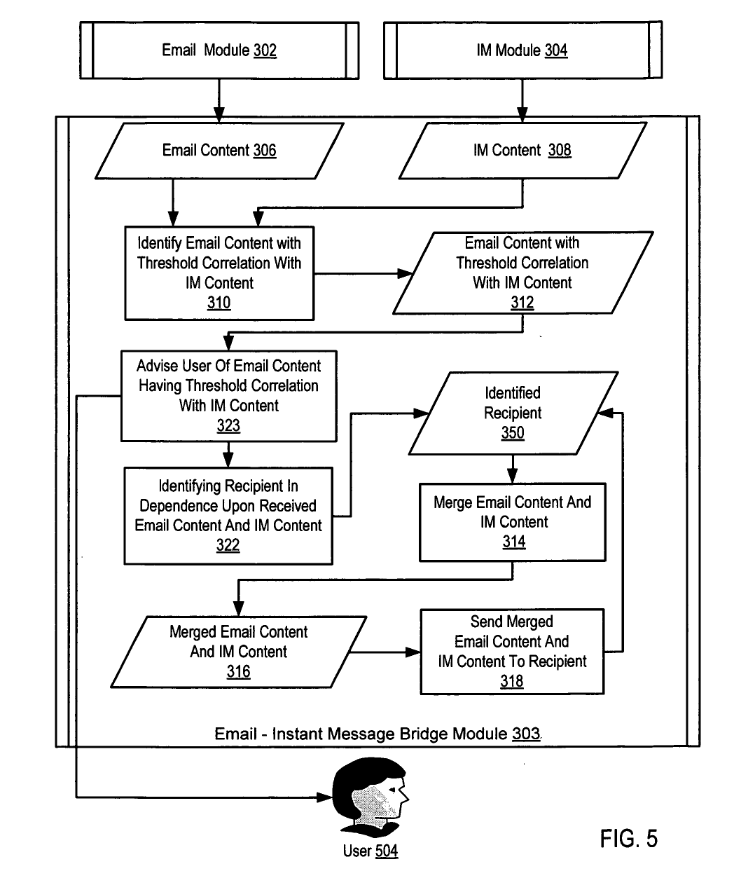

For further explanation, FIG. 5 sets forth a flow chart illustrating a further exemplary method for synchronizing email content with IM content according to embodiments of the present invention. The exemplary method of FIG. 5 is similar to the method of FIG. 3. That is, the method of FIG. 5 includes identifying (310) email content (312) having at least a threshold correlation with IM content (308), merging (314) the email content (306) and IM content (308), and sending (318) the merged (316) email content and IM content to a recipient. The method of FIG. 5, however, also includes advising (323) a user (504) of the email content (312) having a threshold correlation with IM content (308). Advising the user of email content (312) having a threshold correlation with IM content (308) may be carried out by generating a pop-up window with a list of email messages having a threshold correlation with IM content (308), and prompting the user for an instruction to send a message including the merged email content and IM content. Advising the user of email content having a threshold correlation with IM content (308) may also be carried out by sending the user an email message, by sending the user an IM message, or by playing the user an earcon or speech advisement of the threshold correlation. In case of urgent or high priority emails or IM messages having a threshold correlation, advising the user of email content having a threshold correlation with IM content (308) may also include notifying the user of both the correlation and the priority or urgency of the message.

The method of FIG. 5 also includes identifying (322) a recipient (350) in dependence upon the email content (306) and IM content (308). One way of identifying (322) a recipient (350) in dependence upon the email content (306) and IM content (308) can be carried out by generating a list of participants in the email messages containing the email content and generating a list of participants in the IM messages containing the IM content, comparing the lists, and selecting a participant omitted in one of the lists. Consider the following example. Jim sends an email message to Joe, with a copy to Jane. Jane replies with an IM message to Jim. The content of the email message has at least a threshold correlation with the content of the IM message. In this example, Joe is selected as a recipient for the merging content because Joe is a participant in the email message as a recipient and is not a participant in the IM message.

Identifying (322) a recipient (350) in dependence upon the email content (306) and IM content (308) may also include receiving a user instruction identifying the recipient. An email-IM bridge module carrying out the method of FIG. 5 may present to a user a list of possible recipients for the user's selection. The list may consist of the list of participants in the email messages containing the email content or the IM messages containing the IM content which has a threshold correlation with the IM message, or of a combined list of participants from multiple email messages that have a threshold correlation with the IM message. The user of the application may select one or more names from the list as recipients. The user may add additional recipients not on the list, or may reject all of the names on the list and designate as recipient one or more other names.

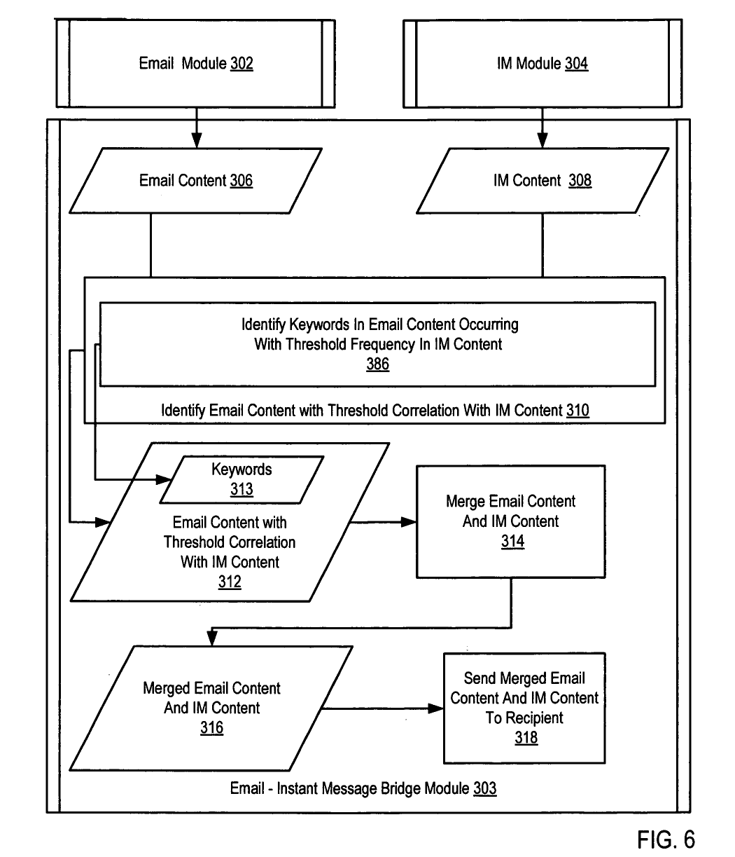

For further explanation, FIG. 6 sets forth a flow chart illustrating a further exemplary method for synchronizing email content with IM content according to embodiments of the present invention. The exemplary method of FIG. 6 is similar to the method of FIG. 3. That is, the method of FIG. 6 includes identifying (310) email content (312) having at least a threshold correlation with IM content (308), merging (314) the email content (306) and IM content (308), and sending (318) the merged (316) email content and IM content to a recipient.

In the method of FIG. 6, however identifying (310) email content having at least a threshold correlation with IM content further includes identifying (386) keywords (313) in the email content occurring with a threshold frequency in the IM content. Identifying keywords from the email content (306) may be carried out by extracting all the words from the email content other than common or predefined articles, conjunctions, prepositions, auxiliary verbs, adverbs, and other words or phrases that are predefined not to be keywords. Extracting all the words from the email content other than common or predefined articles, conjunctions, prepositions, auxiliary verbs, adverbs, and other words or phrases that are predefined not to be keywords is presented here for explanation and not for limitation. Identifying keywords may be carried out in a variety of ways as will occur to those of skill in the art, and all such ways are well within the scope of the present invention.

Identifying (386) keywords (313) in the email content occurring with a threshold frequency in the IM content may be carried out by determining if keywords in the email content occur with a threshold frequency in the IM content. Determining if keywords in the email content occur with a threshold frequency in the IM content includes searching the IM content for matching keywords, counting the matches, and comparing the matches with a threshold frequency value.

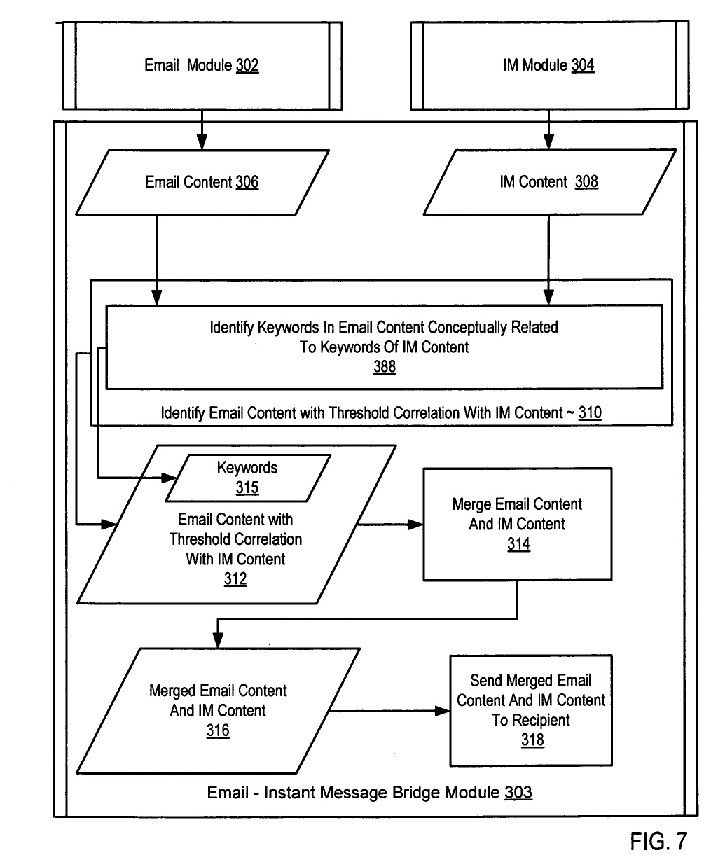

For further explanation, FIG. 7 sets forth a flow chart illustrating a further exemplary method for synchronizing email content with IM content according to embodiments of the present invention. The exemplary method of FIG. 7 is similar to the method of FIG. 3. That is, the method of FIG. 7 includes identifying (310) email content (312) having at least a threshold correlation with IM content (308), merging (314) the email content (306) and IM content (308), and sending (318) the merged (316) email content and IM content to a recipient.

In the method of FIG. 7, however identifying (310) email content having at least a threshold correlation with IM content further includes identifying (388) keywords in the email content conceptually related to other keywords of the IM content. Identifying (388) keywords (315) in the email content conceptually related to other keywords of the IM content may be carried out by extracting keywords from the email content, by generating additional keywords conceptually related to the extracted keywords, and by searching for occurrences of the additional keywords in the IM content. The additional keywords may be generated by using synonyms. For example, the keywords “automobile” and “motor vehicle” may be generated from “car”. The additional keywords may be generated by using class relationships, such as subset and superset. For example, “car” may be generated from “Ford Taurus.”

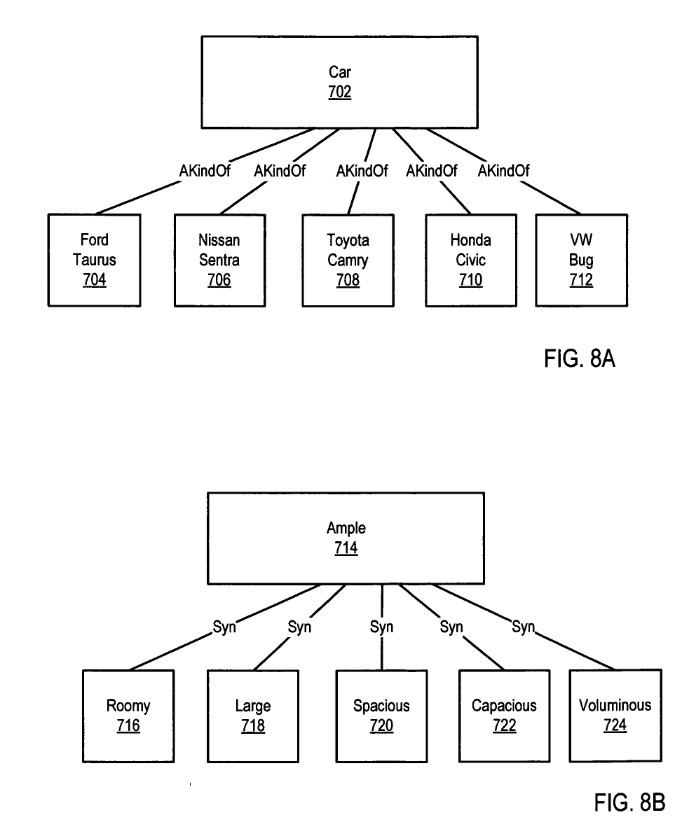

As discussed above, generating keywords conceptually related to the keywords extracted from the email message may be carried out by examining class relationships. For further explanation, FIG. 8A sets forth a line drawing of semantic net of exemplary data representations useful in systems for synchronizing email content with IM content according to embodiments of the present invention. A semantic net is a graphical network representation of concepts and their relationships. The nodes represent concepts and the links represent relationships between the concepts. The semantic net of FIG. 8A includes nodes representing concepts and links representing class relationships between the nodes. The nodes in FIG. 8A include nodes representing particular models of cars, a Ford Taurus (704), a Nissan Sentra (706), a Toyota Camry (708), a Honda Civic (710), and a VW Bug (712). The nodes in FIG. 8A also include car (702), representing a generic car. An “AKindOf” link between a node representing a particular model of cars and node (702) representing a generic car represents a subclass/class relationship between the particular model and the generic car. That is, the subclass is “a kind of” the generic class. For example, Toyota Camrys are a subclass, or kind of, car.

The data structures in FIG. 8A may be used to generate conceptually related keywords. Following a link from one node to another generates a conceptually related keyword. The keyword represented by the first node is conceptually related to the keyword represented by the other node. For example, following the AKindOf link from the Toyota Camry (708) node leads to the car (702) node. This link indicates that the concept “Toyota Camry,” represented by node (708), is conceptually related to the concept “car,” represented by node (702).

As discussed above, generating keywords conceptually related to the keywords extracted from the email message may be carried out by examining synonyms. For further explanation, FIG. 8B sets forth a further line drawing illustrating a semantic net of exemplary data representations useful in systems for synchronizing email content with IM content according to embodiments of the present invention. The semantic net of FIG. 8B includes nodes representing concepts and links representing a synonym relationship between the nodes. The nodes in FIG. 8B represent adjectives. The nodes include ample (714), roomy (716), large (718), spacious (720), capacious (722), and voluminous (724). The “Syn” link between the ample node (714) and the other nodes indicate that the other nodes are synonyms for “ample”.

The data structures in FIG. 8B may be used to generate conceptually related keywords. Following a link from one node to another generates a conceptually related keyword. The keyword represented by the first node is conceptually related to the keyword represented by the other node. For example, following the Syn link from the large (718) node leads to the ample (714) node. This link indicates that the concept “large,” represented by node (718), is conceptually related to the concept “ample,” represented by node (714).

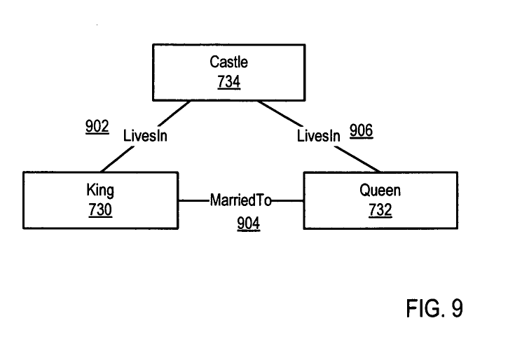

For further explanation, FIG. 9 set forth a further line drawing of a semantic net of exemplary data representations useful as another way of identifying keywords in email content conceptually related to other keywords of IM content according to embodiments of the present invention. As discussed above, a semantic net is a graphical network representation of concepts and their relationships. The nodes represent concepts and the links represent relationships between the concepts. Semantic nets may be obtained over the Internet. For example, WordNet® is an online semantic net maintained and made available by Princeton University. Semantic nets may also be constructed by building a parser and applying the parser to the words in the domain of interest.

FIG. 9 illustrates an exemplary semantic net with nodes representing three concepts, castle (734), king (730), and queen (732). The links represent relationships between the nodes. The links (902 and 906) indicate a “lives in” relationship between a person, the king and queen, and an object, the castle. The link (904) indicates a “married” relationship between a husband, the king, and a wife, the queen.

“Spreading activation” provides an iterative process for traversing a semantic net to identify the relationships between the nodes defined by the links. At the first iteration of traversing the semantic net, certain nodes are activated. At successive iterations, neighboring nodes of activated nodes are in turn activated. The process of spreading activation may terminate after a fixed number of iterations, after all nodes are activated and the relationships between the nodes are identified.

The illustrative methods of identifying keywords in email content conceptually related to other keywords of IM content are presented for explanation, not for limitation. Identifying keywords in email content conceptually related to other keywords of IM content according to embodiments of the present invention may also be performed by inferring the meaning of words based on the context in which they are used, by measuring the conceptual relationship between words, and by considering the theme of an entire document to determine the meaning of words in the document and their relationship with words contained in another document, and other ways that will occur to those of skill in the art.

### Use Case

For further explanation consider the following exemplary use case. In this exemplary use case, the following email message is sent from Joe to Jim with Jack and John copied on the message:

Email:

From: Joe Sent: 5/20/2005 1:28 PM

To: Jim

CC: Jack, John

Subject: Borrow Car?

Jim,

Can we borrow a car from the sales department this weekend? It must hold three people, and have ample trunk room.
Thanks.
Joe

In this exemplary use case the following IM message is sent in response from John, who was copied on the email message, only to Joe excluding both Jack and Jim.

IM Message:

From: John Sent: 5/20/2005 2:28 PM

To: Joe

Subject: Borrow Car?

Joe,

We have a Ford Taurus available. It seats four people, and has a large trunk.
I answered, because Jim is out.

In this exemplary use case the IM message sent in response to the original email message from John to Joe excluded two participants of the earlier email message, Jim and Jack, who were copied on the earlier email message.

Synchronizing email content with IM content according to embodiments of the present invention includes identifying email content having at least a threshold correlation with IM content. To identify email content having at least a threshold correlation with IM content in this example an email-IM bridge module extracts the following keywords from the email: “From: Joe”; “Sent: Fri 5/20/2005 1:28 PM”; “To: Jim”; “CC: Jack, John”; “Subject: Borrow Car?”; “Borrow”; “Car”; “Sales Department”; “weekend”; “three”; “people”; “ample”; “trunk”; “room”; “Joe”. In this example an email-IM bridge module identifies the matching keywords “trunk”; “Joe”; “Jim”; “people” and “Subject: Borrow Car?” The email-IM bridge module also generates other keywords conceptually related to some keywords extracted from the email and searches the IM message for the other keywords. In this case an email-IM bridge module generates and finds the following other related keywords “Ford”; “Taurus” and “large.”

In this example, the email-IM bridge module finds a threshold correlation between the email content and the IM content, merges the IM content and the email content into an IM message, and sends the merged content to all the participants of the initial email as the following IM message:

IM Message:

From: Bridge App

To: Joe; Jim; Jack; John

Subject: Merged content

THE FOLLOWING EMAIL CONTENT OF Fri 5/20/2005 1:28 PM

From: Joe
To: Jim
CC: Jack, John
Subject: Borrow Car?
Jim,
Can we borrow a car from the sales department this weekend? It must hold three people, and have ample trunk room.
Thanks.
Joe
   HAS BEEN FOUND TO HAVE A THRESHOLD CORRELATION WITH THE FOLLOWING IM CONTENT OF Sent: Fri 5/20/2005 2:28 PM
From: John
To: Joe
Subject: Borrow Car?
Joe,
   We have a Ford Taurus available. It seats four people, and has a large trunk.
   I answered, because Jim is out.

In the exemplary use case above, the merged IM content and email content is sent to all the participants of the initial email from the email-IM bridge module with additional description inserted that identifies the IM content and the email content.

Exemplary embodiments of the present invention are described largely in the context of a fully functional computer system for synchronizing email content with IM content. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for synchronizing email content with IM content, the method comprising:
identifying email content having at least a threshold correlation with IM content;
merging the email content and IM content; and
sending the merged email content and IM content to a recipient.

2. The method of claim 1 further comprising detecting one or more synchronization triggering events.

3. The method of claim 1 further comprising advising a user of the email content having a threshold correlation with IM content.

4. The method of claim 1 further comprising identifying a recipient in dependence upon the email content and IM content.

5. The method of claim 1, wherein identifying email content having at least a threshold correlation with IM content further comprises identifying keywords in the email content occurring with a threshold frequency in the IM content.

6. The method of claim 1, wherein identifying email content having at least a threshold correlation with IM content further comprises identifying keywords in the email content conceptually related to other keywords of the IM content.

7. An apparatus for synchronizing email content with IM content, the apparatus comprising:
a computer processor;
a computer memory operatively coupled to the computer processor, the computer memory having disposed within it computer program instructions capable of:
identifying email content having at least a threshold correlation with IM content;
merging the email content and IM content; and
sending the merged email content and IM content to a recipient.

8. The apparatus of claim 7, further comprising computer program instructions capable of detecting one or more synchronization triggering events.

9. The apparatus of claim 7, further comprising computer program instructions capable of advising a user of the email content having a threshold correlation with IM content.

10. The apparatus of claim 7, further comprising computer program instructions capable of identifying a recipient in dependence upon the email content and IM content.

11. The apparatus of claim 7, wherein computer program instructions capable of identifying email content having at least a threshold correlation with IM content further comprises computer program instructions capable of identifying keywords in the email content occurring with a threshold frequency in the IM content.

12. The apparatus of claim 7, wherein computer program instructions capable of identifying email content having at least a threshold correlation with IM content further comprises computer program instructions capable of identifying keywords in the email content conceptually related to other keywords of the IM content.

13. A computer program product for synchronizing email content with IM content, the computer program product disposed upon a signal bearing medium, the computer program product comprising computer program instructions capable of:
identifying email content having at least a threshold correlation with IM content;
merging the email content and IM content; and
sending the merged email content and IM content to a recipient.

14. The computer program product of claim 13, wherein the signal bearing medium comprises a recordable medium.

15. The computer program product of claim 13, wherein the signal bearing medium comprises a transmission medium.

16. The computer program product of claim 13, further comprising computer program instructions capable of detecting one or more synchronization triggering events.

17. The computer program product of claim 13, further comprising computer program instructions capable of advising a user of the email content having a threshold correlation with IM content.

18. The computer program product of claim 13, further comprising computer program instructions capable of identifying a recipient in dependence upon the email content and IM content.

19. The computer program product of claim 13, wherein computer program instructions capable of identifying email content having at least a threshold correlation with IM content further computer program instructions capable of comprises identifying keywords in the email content occurring with a threshold frequency in the IM content.

20. The computer program product of claim 13, wherein computer program instructions capable of identifying email content having at least a threshold correlation with IM content further comprises computer program instructions capable of identifying keywords in the email content conceptually related to other keywords of the IM content.
